(19) United States
(12) Patent Application Publication
(10) Pub. No.: US 2019/0302757 A1
(43) Pub. Date: Oct. 3, 2019

(54) COMPUTER SYSTEM AND COMPUTER PROGRAM

(71) Applicant: NIDEC-SHIMPO CORPORATION, Nagaokakyo-city (JP)

(72) Inventor: Syunta SATO, Nagaokakyo-city (JP)

(21) Appl. No.: 16/368,941

(22) Filed: Mar. 29, 2019

(30) Foreign Application Priority Data
Mar. 30, 2018 (JP) 2018-069761

(51) Int. Cl. G05D 1/00; G06F 3/0484; G01C 21/36

(52) U.S. Cl. CPC G05D 1/0016; G01C 21/3676; G06F 3/04847

(57) ABSTRACT

A computer system for creating a path for a vehicle includes: a processor; a memory configured to store a computer program that controls an operation of the processor; an input device configured to accept an operation by a user; and a display device. In accordance with the computer program, the processor displays, on the display device, a map of a space where the vehicle moves, accepts, from the input device, designation of the k-th (k: an integer satisfying 1≤k≤N−1, N: an integer not less than 2) point and the (k+1)-th point on the map corresponding to passing points of the vehicle, and generates, in response to the acceptance, a composite statement which is a computer-interpretable statement and where a movement permission condition concerning a path k connecting the k-th point and the (k+1)-th point is defined.

### CROSS-REFERENCE TO RELATED APPLICATIONS

This application claims priority to Japanese Patent Application 2018-069761, which was filed on Mar. 30, 2018, the contents of which are hereby incorporated by reference.

### BACKGROUND

### 1. Technical Field

The present disclosure relates to a computer system and a computer program.

### 2. Description of the Related Art

Development of a navigation management system that controls the movement of an automated guided vehicle is under way. An automated guided vehicle is sometimes called an “AGV”. Japanese Laid-Open Patent Publication No. H07-281750 and Japanese Laid-Open Patent Publication No. H08-211937 each disclose a technique of managing the navigation of a vehicle such as an automatic guided vehicle.

As the traveling paths of AGVs have become complicated, a PC and a PLC (Programmable Logic Controller) for navigation management have become necessary for the navigation management system. A PLC is a device inside which a multiplicity of relays, a timer and the like are provided, and is capable of freely interconnecting or disconnecting the relays, the timer and the like with a program. By creating a program in accordance with the navigation contents of an AGV, the navigation of the AGV can be controlled. Further, by appropriately switching the program, changes of navigation contents can be comparatively easily handled.

A PLC includes an input-output interface. The PLC is connected to controlled devices on the traveling path, e.g., an elevator and a sheet shutter, through the input-output interface. The PLC is capable of receiving signals from the controlled devices by using the program, and outputting signals to control the controlled devices.

As described above, in applications where a plurality of AGVs are navigated in parallel and their traveling route(s) is changed as appropriate, the use of a PLC has been suitable. In recent years, it has been virtually essential to use a PLC for the navigation management of AGVs.

### SUMMARY

When the navigation contents of each AGV are created, it may be necessary for a human navigation manager to not only provide a PC for navigation management purposes but also a PLC. In addition, it may be necessary to separately purchase and/or construct a program development environment and acquire knowledge to create a program. Introduction of the system requires not only a monetary cost but also a human cost to create and edit the program.

A non-limiting and illustrative aspect of the present disclosure provides an environment for easily and quickly setting and editing navigation contents for an AGV.

A computer system of the present disclosure may be, in an illustrative aspect of the disclosure, a computer system for creating a path for a vehicle which computer system may include: a processor; a memory storing a computer program that controls an operation of the processor; an input device that accepts an operation by a user; and a display device, in accordance with the computer program, the processor (a) displays, on the display device, a map of a space where the vehicle moves, (b) accepts, from the input device, designation of a k-th (k: an integer satisfying 1≤k≤N−1, N: an integer not less than 2) point and a (k+1)-th point on the map corresponding to passing points of the vehicle, and (c) generates, in response to the acceptance, a composite statement which may be a set of computer-interpretable statements and in which a movement permission condition concerning a path k connecting the k-th point and the (k+1)-th point may be defined.

With a computer system according to one aspect of the present disclosure, the user designates two points corresponding to the passing points of a vehicle through the input device, while viewing a map of the space displayed on the display device. In response to acceptance of the designation, the processor of the computer system generates a computer-interpretable statement in which a movement permission condition concerning a path connecting the two points may be defined. Creation of the movement permission condition, which would have required manual inputs in a conventional system having a PC and a PLC, can be automatized, and thus the navigation contents for the AGV can be easily and quickly created.

### BRIEF DESCRIPTION OF THE DRAWINGS

FIG. 1 is a view showing an overview of a management system 100 according to the present disclosure.

FIG. 2 is a view showing an example in which a user 3 causes an AGV 10 to travel by using a tablet computer 4.

FIG. 3 is an external view of an illustrative AGV 10 according to an illustrative aspect of the disclosure.

FIG. 4 is a view showing a hardware configuration of the AGV 10.

FIG. 5 is a view showing pieces of data of the own position (x, y, θ) of the AGV 10 and the reliability displayed on an screen area 7 of the tablet computer 4.

FIG. 6 is a view showing a hardware configuration of a travel management device 20.

FIG. 7 is a view showing an example of an image 60 displayed on a monitor 30 when the travel management device 20 is started.

FIG. 8 is a view showing an example of an image 110 displayed on the monitor 30 after a button object 63c (FIG. 7) is selected.

FIG. 9 is a view showing an example of marker objects 116a, 116b and 116c indicated at the positions 114a, 114b and 114c selected by the user 3, respectively.

FIG. 10 is a view showing an example of a first image 120 displayed on the monitor 30 after a button object 63d (FIG. 7) is selected.

FIG. 11 is a view showing an example of a second image 130 displayed on the monitor 30 after the button object 63d (FIG. 7) is selected.

FIG. 12A is a view showing a traveling path of the AGV 10 when the AGV 10 travels in a straight line.

FIG. 12B is a view showing a traveling path of the AGV 10 when the AGV 10 turns left at a position Mₙ₊₁ and moves toward a position Mₙ₊₂.

FIG. 12C is a view showing a traveling path of the AGV 10 when the AGV 10 moves in an arc-shaped line from the position Mₙ₊₁ to the position Mₙ₊₂.

FIG. 13 is a view showing an example of marker objects 118a to 118d respectively displayed in positions designated by the user in sequence.

FIG. 14 is a view showing an example in which the marker objects 118a and 118b are displayed according to the user's designation, and thereafter a path R0001 may be set by the program.

FIG. 15A is a view showing an example of a movement permission condition (composite statement) that is set according to the program.

FIG. 15B is a view showing an example of a ladder diagram generated based on the composite statement of FIG. 15A and displayed on the monitor 30.

FIG. 16 is a view showing an example in which the marker object 118c is further displayed according to the user's designation, and thereafter a path of an identifier “R0002” is set by the program.

FIG. 17 is a view showing an example of the ladder diagram, displayed on the monitor 30, where the movement permission condition concerning the traveling path R0002 is defined.

FIG. 18 is a ladder diagram where the movement permission condition to sequentially move the four marker objects shown in FIG. 13 is described.

FIG. 19 is an operation flowchart of the travel management device 20 performed by the program according to the illustrative aspect of the disclosure.

FIG. 20 is a view showing an example of four traveling paths R0011 to R0014 passing three marker objects M₀₀ to M₀₂.

### DETAILED DESCRIPTION

Hereinafter, an example of a management system including a vehicle and a travel management device according to the present disclosure will be described with reference to the attached drawings. In the present specification, an automated guided vehicle (AGV) is described as an example of the vehicle.

In a management system that manages the travel of AGVs according to the present aspect of the disclosure, when the operation of each AGV is controlled, it is not essential to use a PLC. Details thereof will be specifically described with reference to FIG. 13 and subsequent figures.

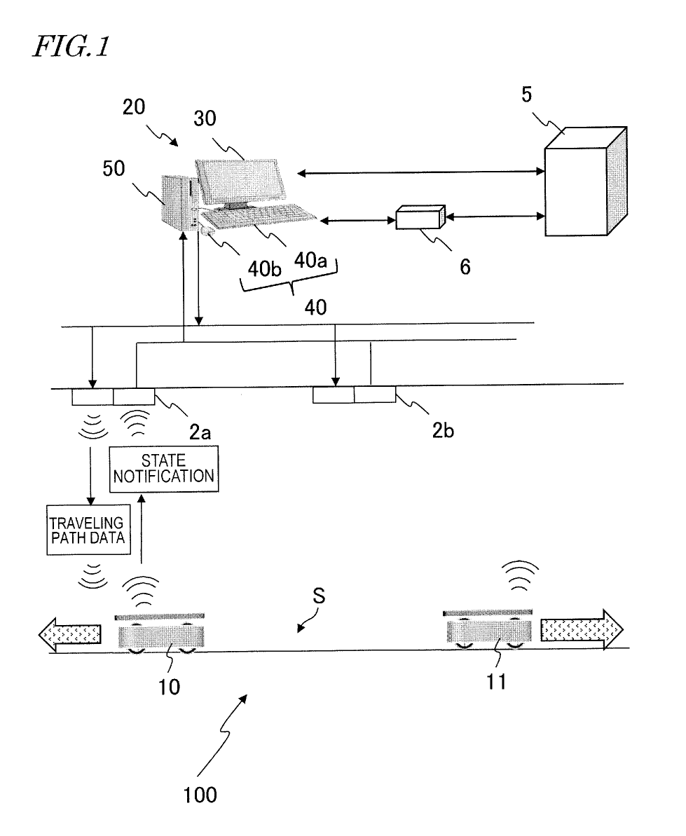

FIG. 1 shows an overview of the management system 100 according to the present disclosure. In the illustrated example, AGVs 10 and 11 have map data, and travel while recognizing at which position they are traveling now. The AGVs 10 and 11 each receive traveling path data transmitted from a travel management device 20, and travel in a space S in accordance with the traveling path data. The AGVs 10 and 11 each move by driving a plurality of internal motors to rotate wheels (drive wheels) that are connected to the motors so as to travel along the traveling path. The traveling path data may be wirelessly transmitted from the travel management device 20 to the AGVs 10 and 11. Communication between the AGV 10 and the travel management device 20 and communication between the AGV 11 and the travel management device 20 are each performed by using radio access points 2a and 2b provided in the neighborhood of the ceiling of a factory. The communications conform to, for example, any of the Wi-Fi® standards. The number of radio access points may be arbitrary.

While two AGVs 10 and 11 are shown in FIG. 1, the number of AGVs may be one, or may be three, four, or five or more. The travel management device 20 generates the traveling path data for each AGV, and transmits it to each AGV.

The AGVs managed by the travel management device 20 are, for example, AGVs which have been registered in the travel management device 20 by a user. As used herein, the state of being “managed” encompasses not only the above-described management of the traveling path, but also navigation management of each AGV, management of states such as a traveling state and a stopped state, management of an error history, and management of a traveling path history.

In the following description, description will be given by taking the AGV 10 as an example. The following description may be similarly applicable also to the AGV 11 and other AGVs (not shown).

An overview of an operation of the management system 100 may be as follows: The management system 100 may include at least one AGV 10 and the travel management device 20, and may manage the travel of the AGV 10 by using the travel management device 20.

The travel management device 20 may include a monitor 30 as an image display device, a keyboard 40a and a mouse 40b as input devices with which to accept the user's operations, and a PC 50. The keyboard 40a and/or the mouse 40b are devices that accept designation of a plurality of positions on the monitor 30 from the user. In the present specification, the keyboard 40a and the mouse 40b are collectively referred to as the “input device 40”. As described later, the PC 50 may include a CPU (Central Processing Unit) as a signal processing circuit, an image processing circuit that generates an image displayed on the monitor 30, and a communication circuit. Generally, the monitor 30, the keyboard 40a and the mouse 40b, and the PC 50 are, as a whole, referred to as a “PC” or “computer system”. The travel management device 20 shown in FIG. 1 may be called a “management PC” or “management computer”. The management PC may be a laptop PC.

On the monitor 30, a planar map image of the space S obtained through a data terminal (not shown) may be displayed. The user can specify a position on the planar map image of the space S as a traveling via-point of the AGV 10.

The image processing circuit generates an image including a plurality of marker objects representing a plurality of positions. An image of a marker object may be, for example, “▪”. Specific examples will be described later. The images of the marker objects may be additionally displayed on the image on the monitor 30 every time a position may be designated, or may be collectively displayed on the monitor 30 after the user performs an operation to complete designation after a plurality of positions are designated. In the present specification, placing an image of a marker object onto the planar map image will be sometimes called “disposing a marker”. Moreover, information concerning the attributes of a marker object (described later) will be sometimes referred to as “marker attribute information”.

The CPU 21 converts the coordinates of each marker object on the image to coordinates in the space S where the AGV 10 travels. At this time, the CPU converts the line segments or the curved lines on the monitor 30 connecting a plurality of marker objects to a path in the space S, and sets them as a traveling path for the AGV 10. The communication circuit transmits data representing the traveling path to the AGV 10.

The AGV 10 may include a communication circuit, and receives data representing the traveling path from the travel management device 20. The AGV 10 may further include a plurality of motors, a plurality of drive wheels respectively connected to the motors, driving devices for the respective motors, and a control circuit. When the control circuit generates a control signal for causing the AGV 10 to travel along the traveling path, e.g., a PWM signal, the driving devices independently control the voltages applied to the motors in accordance with the PWM signal. This causes the motors to rotate so that the AGV 10 moves along the traveling path received from the travel management device 20.

The travel management device 20 may be communicably connected to an external system 5. The travel management device 20 may be capable of performing a serial communication conforming to the Ethernet® standard with the external system 5. Alternatively, the travel management device 20 may communicate with the external system 5 through a PLC communication terminal 6. At this time, a serial communication conforming to the Ethernet® standard may be performed between the travel management device 20 and the PLC communication terminal 6, and a serial communication using a power line may be performed between the PLC communication terminal 6 and the external system 5.

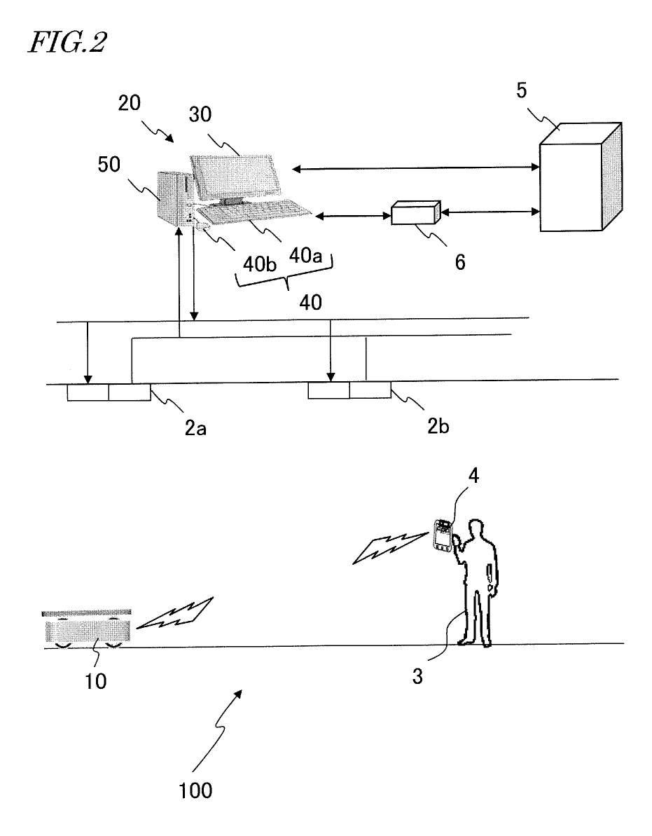

FIG. 1 shows an example in which the travel management device 20 transmits information of a traveling path to the AGV 10 to thereby manage the travel of the AGV 10. However, the user may directly operate the AGV 10 by using a communication terminal, e.g., a tablet computer. FIG. 2 shows an example in which the user 3 causes the AGV 10 to travel by using a tablet computer 4. The tablet computer 4 and the AGV 10 may be connected e.g. one-to-one to perform a communication conforming to the Bluetooth® standard, or may perform a communication conforming to the Wi-Fi® standard through the radio access points 2a and 2b or the like.

When the AGV 10 is directly operated by using the tablet computer 4, even if the traveling path data is received from the travel management device 20, the AGV 10 travels in accordance with the operation made by the user 3. While the connection with the tablet computer 4 is disconnected, the AGV can travel in accordance with the traveling path data received from the travel management device 20.

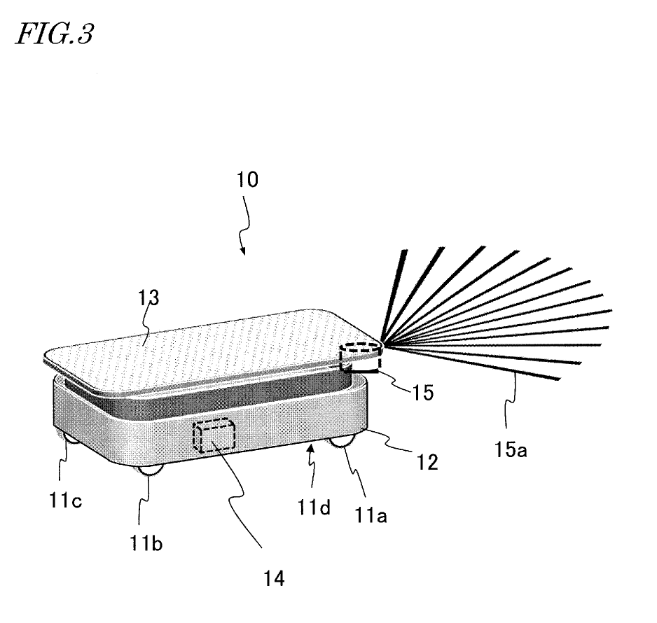

Next, referring to FIG. 3 to FIG. 6, the structure of the AGV 10 and the travel management device 20 will be described.

FIG. 3 is an external view of an illustrative AGV 10 according to the present aspect of the disclosure. The AGV 10 may include four wheels 11a to 11d, a frame 12, a carrying table 13, a travel control device 14 and a laser range finder 15. Although the AGV 10 may also include a plurality of motors, they are not shown in FIG. 3. Moreover, although the front wheel 11a, the rear wheel 11b and the rear wheel 11c are shown in FIG. 3, the front wheel 11d which is obscured behind the frame 12 is not clearly shown.

The travel control device 14 may be a device that controls the operation of the AGV 10, and may mainly include an integrated circuit including an MCU (described later), electronic parts and a circuit board on which these are mounted. The travel control device 14 performs the above-described data transmission and reception to/from the travel management device 20, and a preprocessing operation.

The laser range finder 15 may be an optical device that measures a distance to a target, for example, by applying infrared laser light 15a to the target and detecting the reflected light of the laser light 15a. In a present aspect of the disclosure, the laser range finder 15 of the AGV 10 emits the pulsed laser light 15a while changing the direction every 0.25 degrees, for example, in a space spanning a range of 135 degrees on the left and right sides (a total of 270 degrees) of e.g. the front of the AGV 10, and detects the reflected light of each laser light 15a. This provides data of distance to the reflection point in directions determined by a total of 1081 steps of angle in every 0.25 degrees.

From the position and attitude of the AGV 10 and the result of scanning by the laser range finder 15, the disposition of the objects around the AGV can be obtained. Generally speaking, the position and attitude of a vehicle are referred to a pose. The position and attitude of a vehicle within a two-dimensional surface are expressed by positional coordinates (x, y) in an XY orthogonal coordinate system and an angle θ to the X axis. Hereinafter, the position and attitude, that is, the pose (x, y, θ) of the AGV 10 may simply be referred to as “position”.

The position of a reflection point as viewed from the position at which the laser light 15a is emitted can be expressed by using polar coordinates that are defined in terms of angle and distance. In this aspect of the disclosure, the laser range finder 15 outputs sensor data that may be expressed in polar coordinates. However, the laser range finder 15 may convert a position that is expressed in polar coordinates into a position expressed in Cartesian coordinates, and may output the converted position data.

Since the structure and operation principles a laser range finder are well-known, any more detailed description thereof will be omitted in the present specification. Examples of objects that can be detected by the laser range finder 15 may include humans, cargo, shelves, and walls.

The laser range finder 15 may be an example of an external sensor that acquires sensor data by sensing the area therearound. Other examples of such external sensors may include image sensors and ultrasonic sensors.

The travel control device 14 can estimate the current position of the device itself by comparing the measurement results of the laser range finder 15 with the map data stored in itself. The map data may be obtained by the AGV 10 itself by using the SLAM (Simultaneous Localization and Mapping) technique.

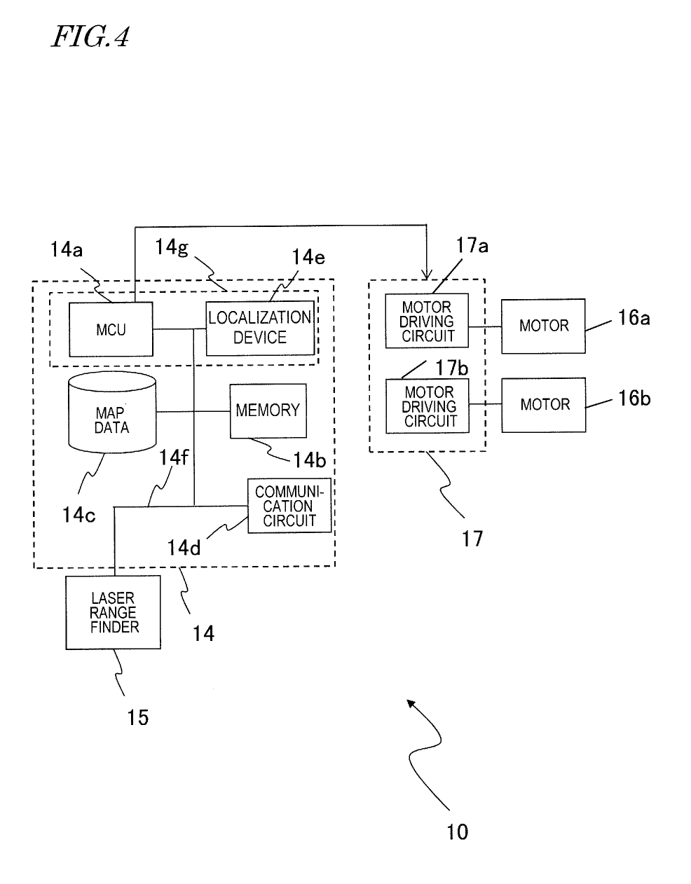

FIG. 4 shows the hardware configuration of the AGV 10. FIG. 4 also shows a specific structure of the travel control device 14.

The AGV 10 may include the travel control device 14, the laser range finder 15, two motors 16a and 16b, and a driving device 17.

The travel control device 14 may include an MCU 14a, a memory 14b, a storage device 14c, a communication circuit 14d and a localization device 14e. The MCU 14a, the memory 14b, the storage device 14c, the communication circuit 14d and the localization device 14e are connected by a communication bus 14f, and are capable of transmitting and receiving data to/from one another. Moreover, the laser range finder 15 may be also connected to the communication bus 14f through a communication interface (not shown), and transmits the measurement data as the measurement result to the MCU 14a, the localization device 14e and/or the memory 14b.

The MCU 14a may be a processor or a control circuit (computer) that performs an operation for controlling the whole of the AGV 10 including the travel control device 14. Typically, the MCU 14a is a semiconductor integrated circuit. The MCU 14a transmits a PWM (Pulse Width Modulation) signal as a control signal to the driving device 17 to control the driving device 17 and causes it to adjust the voltages applied to the motors. As a result, the motors 16a and 16b each rotate at a desired rotation speed.

The memory 14b may be a volatile storage device that stores a computer program executed by the MCU 14a. The memory 14b may be usable as a work memory when the MCU 14a and the localization device 14e perform an operation.

The storage device 14c may be a non-volatile semiconductor memory that stores the map data. However, the storage device 14c may be a magnetic recording medium typified by a hard disk or an optical recording medium typified by an optical disc. Further, the storage device 14c may include a head device for writing and/or reading data to and/or from any of the recording media, and a control device for the head device. In a present aspect of the disclosure, the map data may be obtained prior to the start of the travel of the AGV 10 and stored in the storage device 14c.

The communication circuit 14d may be a radio communication circuit that performs radio communication conforming to, for example, the Bluetooth® and/or the Wi-Fi® standard. Either of such standards may include radio communication standards in which a 2.4 GHz frequency band is used.

The localization device 14e receives the sensor data from the laser range finder 15, and reads out the map data stored in the storage device 14c. By matching the local map data created from the result of scanning by the laser range finder 15 against environment map data of a wider range, the localization device 14e identifies its own position (x, y, θ) on the environment map. The localization device 14e generates “reliability” representing the degree of coincidence of the local map data with the environment map data. Pieces of data of the own position (x, y, θ) and the reliability can be transmitted from the AGV 10 to the travel management device 20 and/or the tablet computer 4.

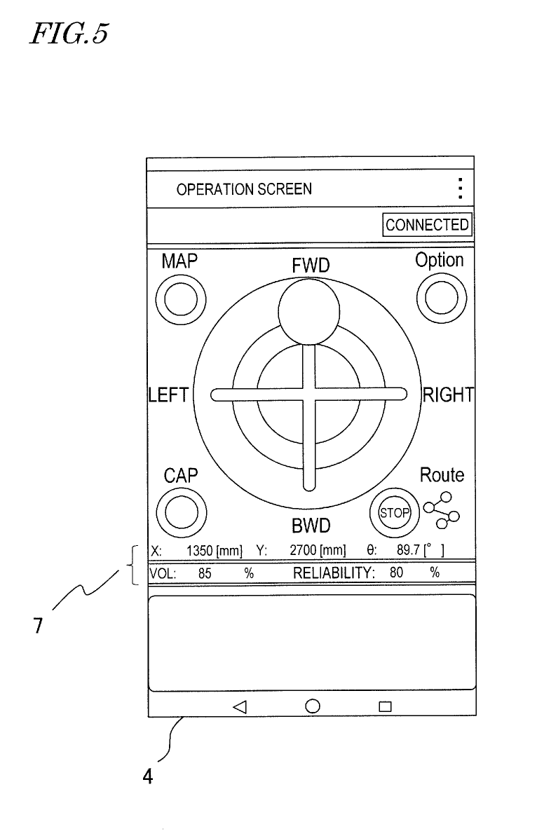

For example, the tablet computer 4 receives the pieces of data of the own position (x, y, θ) and the reliability, and displays them on an internal display device. FIG. 5 shows the pieces of data of the own position (x, y, θ) of the AGV 10 and the reliability displayed on an screen area 7 of the tablet computer 4.

While the MCU 14a and the localization device 14e are illustrated as separate components in the present aspect of the disclosure, this is an example. They may be a one-chip circuit or a semiconductor integrated circuit capable of independently performing the operations of the MCU 14a and the localization device 14e. FIG. 4 shows a chip circuit 14g including the MCU 14a and the localization device 14e. In the present disclosure, the MCU 14a, the localization device 14e and/or the chip circuit 14g are sometimes called a computer or a signal processing circuit. Hereinafter, description will be directed to an example where the MCU 14a and the localization device 14e are separately and independently provided.

The two motors 16a and 16b are attached to the two wheels 11b and 11c to rotate the respective wheels. That is, the two wheels 11b and 11c are drive wheels.

The driving device 17 may include motor driving circuits 17a and 17b for adjusting the voltages applied to the two motors 16a and 16b, respectively. The motor driving circuits 17a and 17b are both so-called inverter circuits, and turn on or off the current flowing through the motors by the PWM signal transmitted from the MCU 14a, thereby adjusting the voltages applied to the motors.

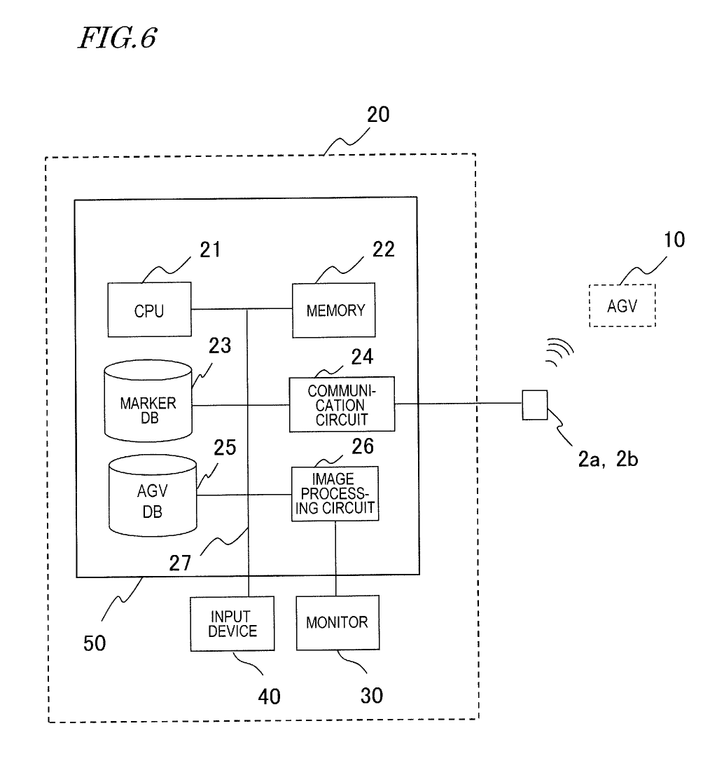

FIG. 6 shows the hardware configuration of the travel management device 20. As described above, the travel management device 20 may include the monitor 30, the input device 40 such as the keyboard 40a and the mouse 40b, and the PC 50.

The PC 50 may include the CPU 21, a memory 22, a maker database (marker DB) 23, a communication circuit 24, an AGV database (AGV DB) 25 and an image processing circuit 26. The CPU 21, the memory 22, the marker DB 23, the communication circuit 24 and the image processing circuit 26 are connected by a communication bus 27, and are capable of transmitting and receiving data to/from one another.

The CPU 21 may be a signal processing circuit (computer) that controls the operation of the travel management device 20. Typically, the CPU 21 is a semiconductor integrated circuit.

The memory 22 may be a volatile storage device that stores a computer program executed by the CPU 21. The memory 22 may be usable as the work memory when the CPU 21 performs computing. The computer program may be stored in a non-volatile storage device (not shown), e.g., an EEPROM. The CPU 21 reads the computer program from the non-volatile storage device when the PC 50 is started, and expands it to the memory 22 to execute it.

The marker DB 23 stores information of a position(s) on the image designated by the user. In the present disclosure, a marker object may be to be disposed at a position on the image designated by the user 3. The marker DB 23 stores various pieces of data related to the marker objects. The marker DB 23 holds a rule that associates positions on the image with coordinates in the space S where the AGV 10 travels. The rule may be held in the memory 22. The marker DB 23 may be constructed on a non-volatile semiconductor memory or may be constructed on a magnetic recording medium such as a hard disk, or an optical recording medium such as an optical disc.

The communication circuit 24 performs wired communication conforming to, for example, the Ethernet® standard. The communication circuit 24 may be connected to the radio access points 2a, 2b and the like by wire, and may be capable of communicating with the AGV 10 through the radio access points 2a, 2b and the like. The communication circuit 24 receives data to be transmitted to the AGV 10, from the CPU 21 through the bus 27. Moreover, the communication circuit 24 transmits data (notification) received from the AGV 10 to the CPU 21 and/or the memory 22 through the bus 27.

The AGV DB 25 stores data of the state of each AGV 10. The AGV DB 25 can be updated by receiving data from each AGV 10, and can also be updated by a case where the traveling path is generated by the CPU 21.

The image processing circuit 26 may be a circuit that generates an image displayed on the monitor 30. The image processing circuit 26 operates exclusively when the user 3 operates the travel management device 20. The monitor 30 and/or the input device 40 may be integrated with the travel management device 20. Moreover, the processing of the image processing circuit 26 may be performed by the CPU 21.

The marker DB 23 and the AGV DB 25 may be the data stored in the storage device itself or may be a combination of a computer program functioning as a database server and data. Alternatively, the marker DB 23 and the AGV DB 25 may be a combination of hardware functioning as a database server and data.

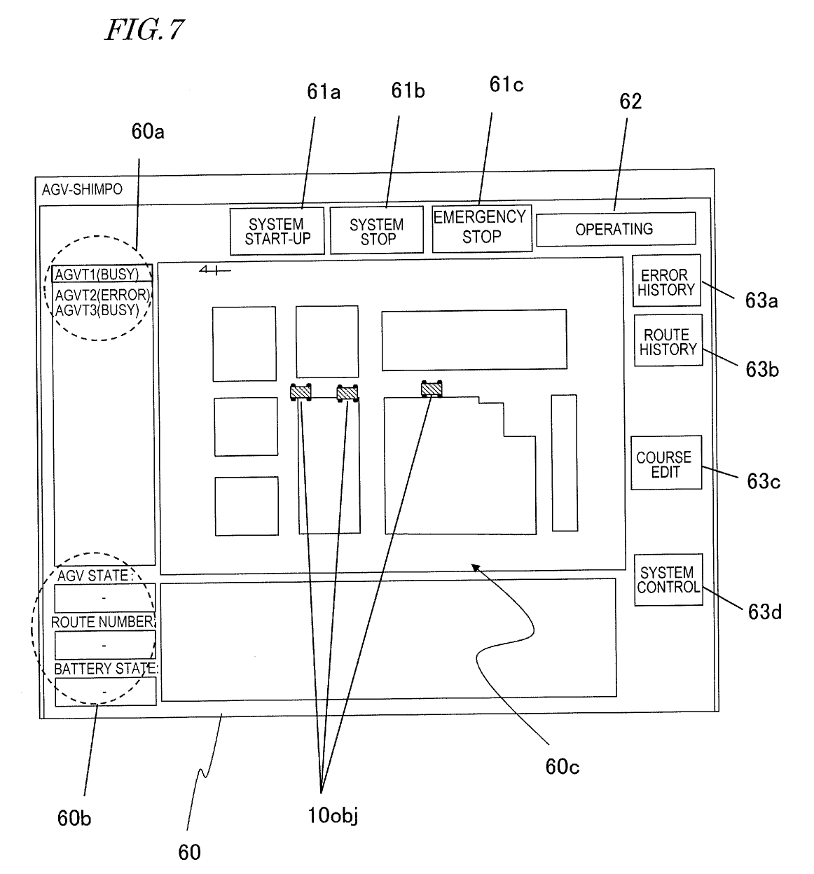

Next, the operation of the travel management device 20 will be described with reference to an example of images displayed on the monitor 30 which example is shown in FIG. 7 to FIG. 9. The CPU 21 of the travel management device 20 executes the computer program stored in the memory 22 to thereby operate in accordance with the user's operation, generates the images described below, and displays them on the monitor 30.

FIG. 7 shows an example of an image 60 displayed on the monitor 30 when the travel management device 20 is started.

The image 60 has a list area 60a, a state display area 60b and a navigation monitor area 60c. In the list area 60a, the AGVs 10 placed under management of the management system 100 by being registered by the user 3 are displayed. In the state display area 60b, the state of the selected AGV 10 is displayed. An example of a “state” is whether the AGV 10 is currently in a traveling state or a stopped state, whether an error exists or not, a number to identify the currently-set traveling path, or the remaining power of the battery.

In the navigation monitor area 60c, a planar map image of the space S where the AGV 10 travels is displayed. The travel management device 20 obtains the image through a data terminal (not shown), incorporates it into the image 60, and displays it. On the planar map image, objects 10obj representing the respective positions of the AGVs 10 displayed in the list area 60a are indicated. As a result, the user 3 can grasp the current position in the space S, and the current state, of each AGV 10.

The image 60 may further include a plurality of button objects 61a to 61c and 63a to 63d. When the user 3 selects a specific button object, the CPU 21 executes the processing associated with the button object, and the image processing circuit 26 generates a new image showing a result of the processing and displays it. The selection of the button object may be achieved, for example, by the user moving a cursor onto a button object by using the mouse 40b and clicking on the button of the mouse 40b. Alternatively, it may be achieved by the user moving a cursor onto the button object by using an up/down/right/left key of the keyboard 40a and depressing the enter button of the keyboard 40a.

The button objects 61a to 61c are provided for the start, stop and emergency stop of the management system 100. In an area 62 of the image 60, the current state of the management system 100 is displayed. In the illustrated example, it is shown that the system is currently operating.

The button objects 63a to 63d are each provided to perform display of an error history of the selected AGV 10, display of a route history thereof, editing of the course as the traveling path, and setting of the operation. Hereinafter, the operation of the travel management device 20 when the button object 63c related to the edit of the course is selected will be described.

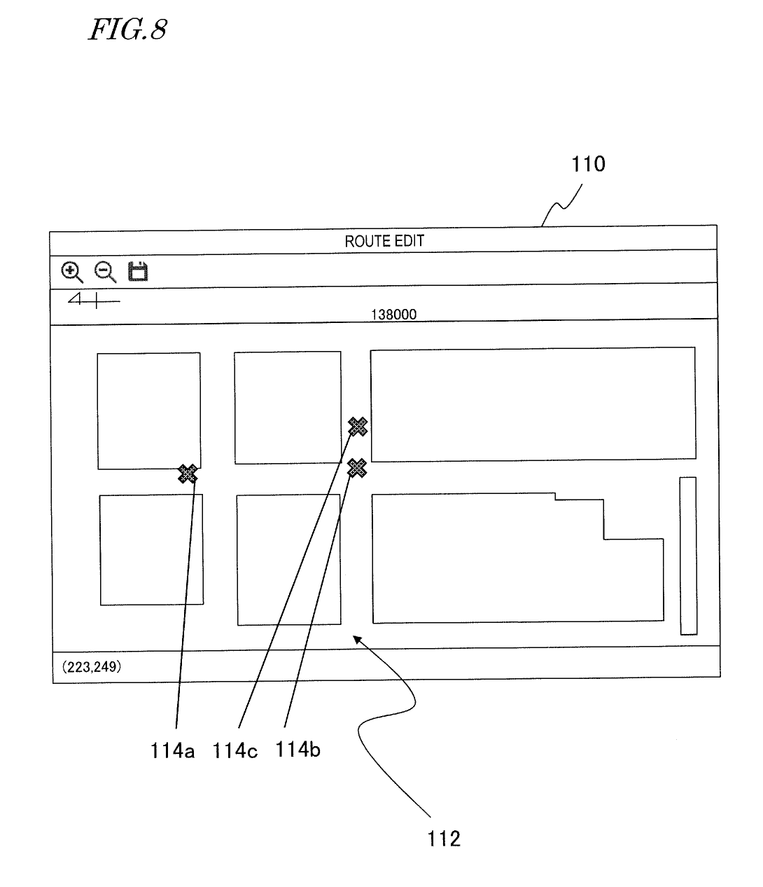

FIG. 8 shows an example of an image 110 displayed on the monitor 30 after the button object 63c (FIG. 7) is selected. In the illustrated example, a planar map image 112 of the space S where the AGV 10 travels is displayed in the image 110. The user 3 can determine a traveling path for the selected AGV 10 by designating positions with the input device 40 on the planar map image 112. In FIG. 8, three positions 114a, 114b and 114c designated by the user are shown by “X”. The user 3 can correct the positions indicated by “X”, if necessary.

It may be assumed that the user 3 designates the positions 114a, 114b and 114c in this order on the planar map image 112. Thereafter, when the user 3 selects a button object (not shown) indicating that the position designation is ended, the CPU 21 transmits to the image processing circuit 26 the coordinates of the positions 114a, 114b and 114c and an instruction to display marker objects at the designated coordinates. In response to reception of the instruction, the image processing circuit 26 generates an image in which marker objects are indicated at the positions selected by the user 3. FIG. 9 shows an example of marker objects 116a, 116b and 116c indicated at the positions 114a, 114b and 114c (FIG. 8) selected by the user 3, respectively. While the shape of each marker object is “▪” in the present aspect of the disclosure, the shape may be arbitrary.

The CPU 21 decides the traveling path so that the AGV 10 will travel through the coordinate positions in the space S corresponding to the positions of the marker objects 116a, 116b and 116c, in the order designated by the user 3. Specifically, the CPU 21 determines a path by which the AGV 10 heads from the position 114a toward the position 114b, and after reaching the position 114b, heads toward the position 114c. The path may be either a straight line or a curved line. The CPU 21 converts the positions of the marker objects and the path on the image, respectively, into coordinates and a traveling path in the space S. For purposes of illustration, coordinates in the space S as converted from the position 116a are expressed as “coordinates A”. Likewise, coordinates in the space S as converted from the positions 116b and 116c are expressed as “coordinates B” and “coordinates C”, respectively. The CPU 21 generates data of a traveling path along which the AGV 10 travels from the coordinates A to the coordinates B, and after reaching the coordinates B, heads toward the coordinates C.

Data of the traveling path may be described according to a predetermined rule. For example, suppose that the user 3 designates a certain marker object, and subsequently another object. For purposes of illustration, the marker object designated first will be referred to as the “first marker object” and the marker object designated next will be referred to as the “second marker object”. The traveling path can be determined by: “connection information” representing the second marker object, toward which the AGV 10 is headed next to the first marker object; and “orbit information” representing the shape of the orbit from the first marker object toward the second marker object. In the present disclosure, information such as the above-described “connection information” and “orbit information” that determines the traveling condition of the AGV 10 will be referred to as “attribute information”. The above-described connection information and orbit information may be included as part of the attribute information of the first marker object.

As described above, the positions of the first marker object and the second marker object on the image are converted to “first coordinates” and “second coordinates” that are coordinates in the space S, respectively. The attribute information of the first marker object may include a pair of an X-axis coordinate and a Y-axis coordinate identifying the first coordinates, and the attribute information of the second marker object may include a pair of an X-axis coordinate and a Y-axis coordinate identifying the second coordinates. The terms “first coordinates” and “second coordinates” are also assigned for purposes of illustration.

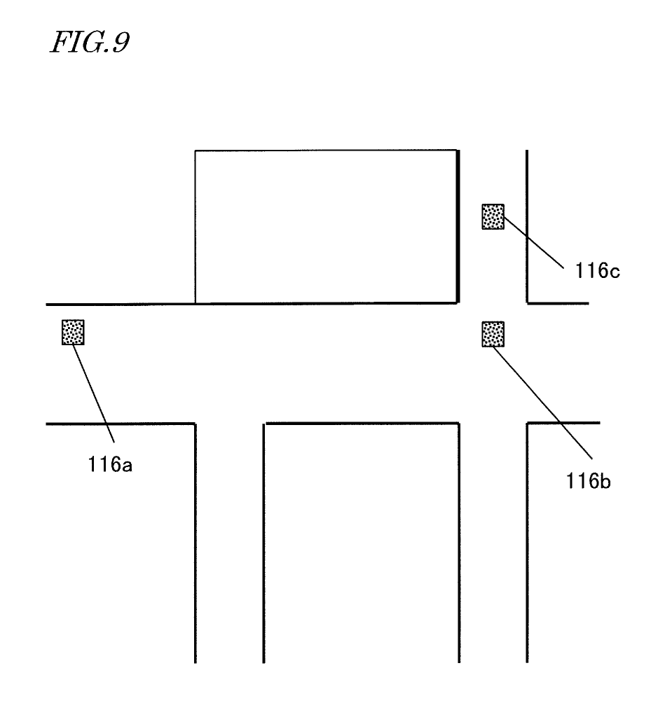

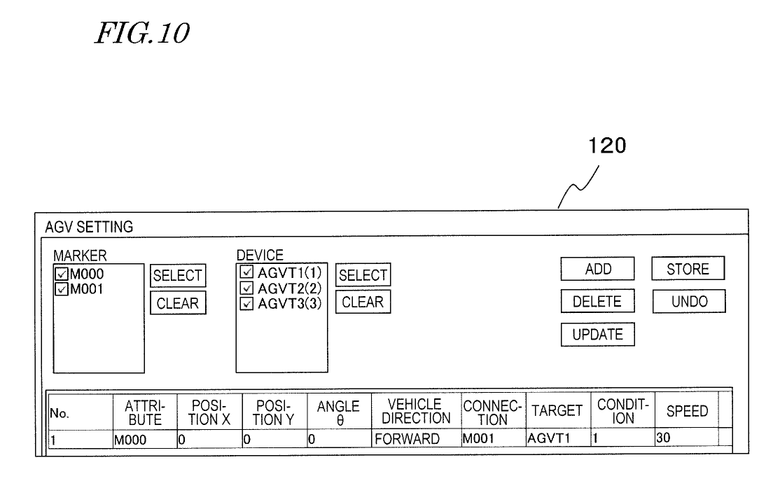

FIG. 10 shows an example of a first image 120 displayed on the monitor 30 after the button object 63d (FIG. 7) is selected. The illustrated example shows a list of attribute information of a certain marker object. An example of the attribute information may be as follows: Here, the coordinates in the space S obtained by converting the coordinates of a marker object designated next to the marker object in question will be referred to as “coordinates of the next target position” (the same also applies below in the present specification).
The ID or the name of the AGV that identifies the AGV 10 which is subject to the traveling condition in question.
The coordinates (x, y) in the space S as converted from the coordinates of the marker object in question.
The angle θ representing the traveling direction of the AGV 10 heading toward the coordinates of the next target position.
The direction of the AGV 10 (“forward” indicating a forward movement, “backward” indicating a backward movement).
The information (name, etc.) representing the marker object designated next to the marker object in question.
The speed of the AGV 10 heading toward the next marker object.

In response the operation by the user 3, the CPU 21 sets or changes the traveling condition for each AGV 10, with respect to each marker object that is set as shown in FIG. 9.

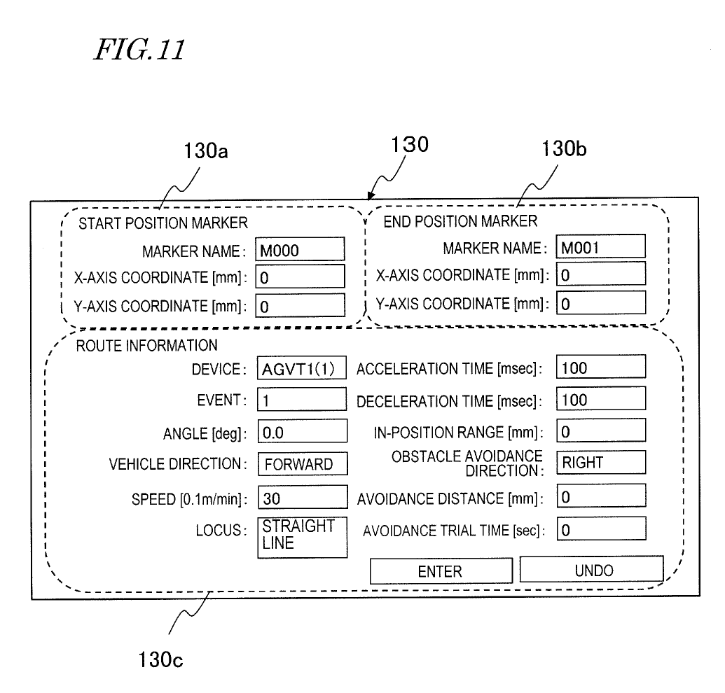

FIG. 11 shows an example of a second image 130 displayed on the monitor 30 after the button object 63d (FIG. 7) is selected. The second image 130 can be displayed when a marker object representing the traveling start position of the AGV 10 and a marker object representing the traveling end position of the AGV 10 are set.

The second image 130 may include three areas 130a, 130b and 130c. The areas 130a and 130b correspond to pieces of attribute information of the marker objects representing the traveling start position and the traveling end position, respectively. Specifically, they are the names of the marker objects and the coordinates (x, y) of the space S converted from the coordinates of the marker objects.

The area 130c shows detailed attribute information related to the traveling path. An example of the attribute information may be as follows:
The ID or the name of the AGV that identifies the AGV 10 which may be subject to the traveling condition in question.
The angle representing the traveling direction of the AGV 10 heading toward the coordinates of the next target position.
The direction of the AGV 10 (“forward” indicating a forward movement, “backward” indicating a backward movement).
The speed of the AGV 10 heading toward the coordinates of the next target position.
The shape of the locus of the traveling path (a straight line, an arc).
The acceleration time and the deceleration time of the AGV 10.
The in-position range.
The avoidance direction (right or left), the distance of avoidance and the length of time of avoidance when an encounter with an obstacle is detected.

The above-mentioned “in-position range” means a range (area) within which the AGV 10 may be regarded as having reached the coordinates of the next target position even though the AGV 10 has not quite reached them. The size of the area may be set for each target position. For example, when it is assumed that the area in question is a circular area centered around the next target position, the user 3 may set the value of the radius of the circular area as attribute information. The unit may be, for example, millimeter.

These may also be set as the attribute information: a charging condition specifying whether or not to perform recharging, based on the residual amount of charging and the like; an entrance prohibition condition specifying an area where entrance of the AGV 10 is prohibited; and the like

As an example method of detecting whether the AGV 10 has reached the area in question or not, use of the output of the localization device 14e (FIG. 4) provided on the AGV 10 might be possible. The AGV 10 matches the output of the localization device 14e against the map data, estimates the best-coinciding position on the map data to be its own position, and determines whether its estimated own position is within the area in question or not.

The user 3 can change the areas 130a, 130b and 130c shown in FIG. 11. The CPU 21 stores the changed attribute information into the AGV DB 25 (FIG. 6), and sets or changes the traveling condition for each AGV 10.

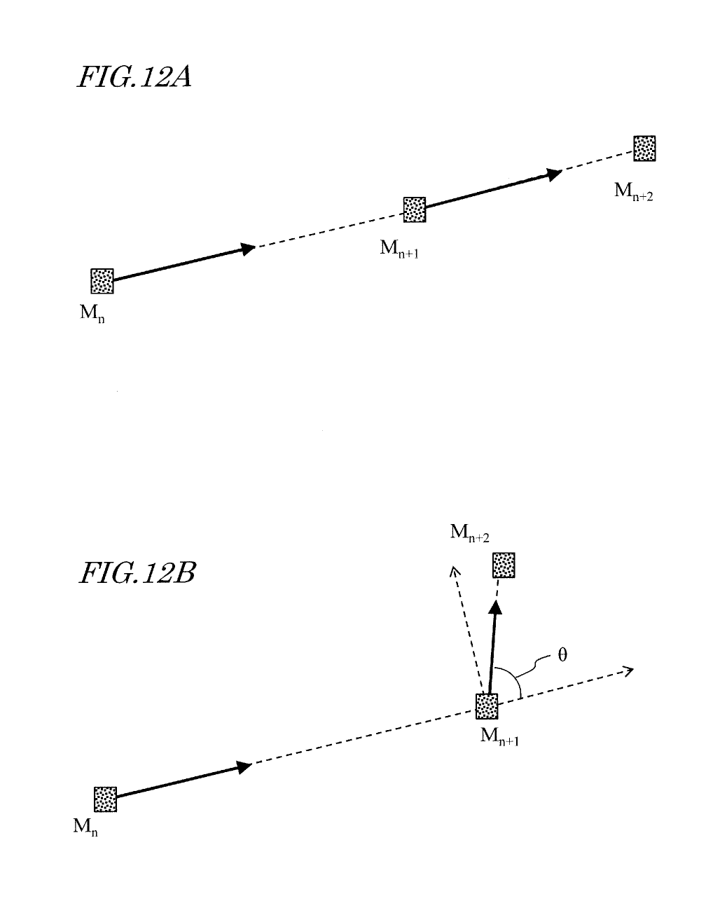

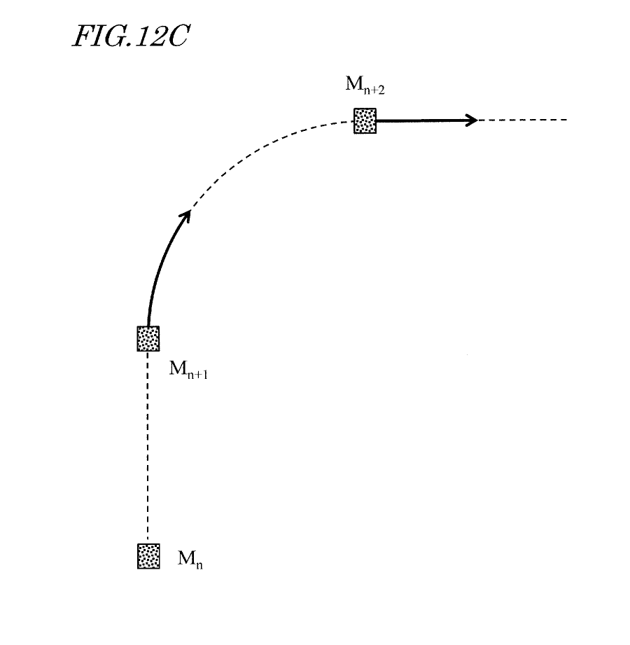

Now, with reference to FIG. 12A to FIG. 12C, the locus of the traveling path of the AGV 10 will be described.

FIG. 12A shows a traveling path of the AGV 10 when the AGV 10 travels in a straight line. The AGV 10 starts traveling from a position Mₙ, and after reaching a position Mₙ₊₁ the AGV 10 can continue to move in a straight line to a position Mₙ₊₂.

FIG. 12B shows a traveling path of the AGV 10 when the AGV 10 turns left at the position Mₙ₊₁ and moves toward the position Mₙ₊₂. The AGV 10 starts traveling at the position Mₙ, and at the position Mₙ₊₁, rotates a motor situated on the right side of the traveling direction and stops a motor situated on the left side of the traveling direction. Then, the AGV 10 rotates counterclockwise by an angle θ at the position and then, travels in a straight line toward the position Mₙ₊₂ with all motors being rotated at an equal speed.

FIG. 12C shows a traveling path of the AGV 10 when the AGV 10 moves in an arc-shaped line from the position Mₙ₊₁ to the position Mₙ₊₂. After the AGV 10 reaches the position Mₙ₊₁, the rotation speed of the motor on the outer side is made higher than that of the motor on the inner side. This enables the AGV 10 to move toward the next position Mₙ₊₂ along an arc-shaped path.

The driving device 17 causes a relative rotation speed difference between the motors 16a and 16b in accordance with the control signal, whereby the AGV 10 can turn or rotate in a direction where the rotation speed is relatively low.

Hereinafter, an example processing of creating a path for the AGV 10, converting it into a ladder diagram, and outputting it by using the management system 100 as a computer system will be described. In the following, for the sake of convenience, an example in which the AGV 10 travels in a straight line between two positions will be described. That is, the locus of the traveling path may be a straight line. However, as mentioned above, the traveling path of the AGV 10 is not limited to a straight movement.

The ladder diagram described below is an example of a “programming language” frequently used in general when a PLC (Programmable Logic Controller) may be used. In addition, for example, a flowchart method, a step ladder method, an SFC (Sequential Function Chart) or the like may be used. While these methods are different from one another, by analogy from the following description one of ordinary skill in the art should be able to handle any method so long as an application program of the management system 100 outputs a “program” of an output form supporting the method.

FIG. 13 shows an example of marker objects 118a to 118d respectively displayed in positions designated by the user in sequence. It is assumed that the marker objects 118a to 118d are arranged in the order by which the user designates them by using the input device 40. It is assumed that the user creates a traveling path for the AGV 10 so that the AGV 10 will pass the marker objects 118a, 118b, 118c and 118d in this order.

When the user designates two positions in sequence to display two marker objects, the computer program according to the present aspect of the disclosure (hereinafter, abbreviated as “program”) generates a path that passes through the two marker objects. That is, the designated positions are meant as passing points of the AGV 10. Hereinafter, the processing of generating the path will be described in detail. Here, the following description is an example. In another example, the user may designate all positions to display all marker objects, and thereafter, the program may collectively generate a traveling path for the AGV 10 as soon as a “store” button (not shown) displayed on the monitor 30 is selected by the user.

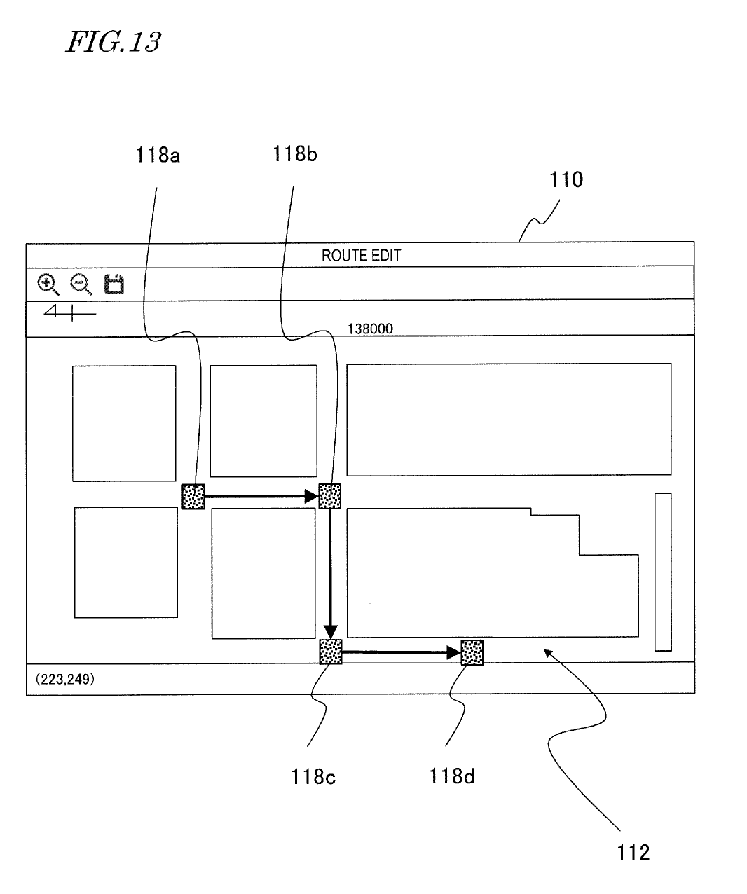

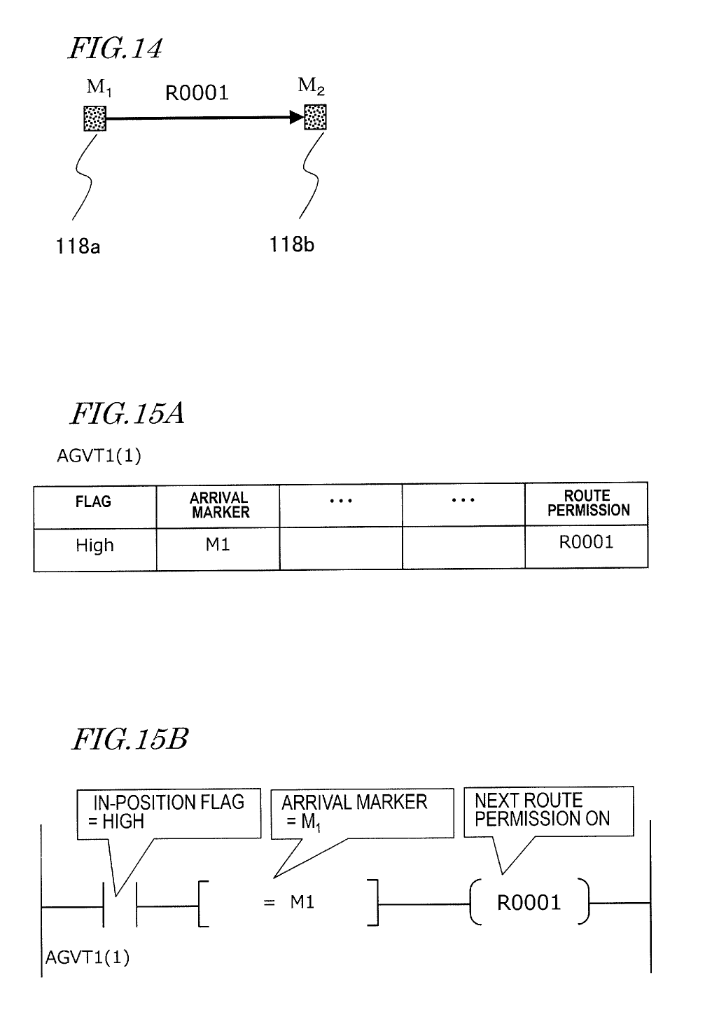

FIG. 14 shows an example in which the marker objects 118a and 118b are displayed according to the user's designation, and thereafter a path R0001 may be set by the program. The designation “R0001” may be an identifier (ID) that uniquely identifies the path, this designation being assigned by the program. For ease of being handled as data, the marker objects 118a and 118b are assigned with designations M₁ and M₂, respectively.

In accordance with the program, the CPU 21 of the travel management device 20 sets the traveling path R0001 heading from the marker object 118a toward the marker object 118b. In addition, the CPU 21 sets a movement permission condition, which may be a condition for permitting movement along the traveling path R0001.

FIG. 15A shows an example of the movement permission condition that may be set in accordance with the program. The movement permission condition may include various conditions.

In the example of FIG. 15A, “High” is set as a “flag”. This means that the AGV 10 reaching the in-position range of a predetermined position (marker) is being required as a condition. The marker whose in-position range is to be reached is described in the next column; in this example, “marker M₁” is set. Lastly, the ID of the path for which movement may be permitted is described in “ROUTE PERMISSION”. Note that, for example, eight such movement permission conditions may be set.

As is understood from the above description, the movement permission condition can be defined as a set of descriptions defining various conditions. The description defining each condition can be regarded as one “statement” in the realm of programming languages. The movement permission condition may be regarded as a “composite statement” that may include a set of a plurality of statements. A composite statement is not necessarily expressed in the form of a table as shown in FIG. 15A, but may be a list of statements. The CPU 21 stores the generated composite statement into the memory 22, or into the AGV DB 25 (FIG. 6) for each AGV 10. The statement may be created in accordance with any arbitrary rule that is interpretable by the CPU 21, and stored.

The travel management device 20 according to a present aspect of the disclosure further generates a ladder diagram by using the composite statement. FIG. 15B shows an example of the ladder diagram generated based on the composite statement of FIG. ISA and displayed on the monitor 30.

The CPU 21 disposes, as a contact point (symbol | |) in the ladder diagram, an arrival flag indicating that the AGV 10 is to reach a predetermined position. The CPU 21 disposes an arrival marker M₁ in between the symbols [ ], as a condition concerning the position information of the “predetermined position”. Further, the CPU 21 places the ID (R0001) of the path representing the next traveling path, as a coil (symbol “( )”) of the output relay of the ladder diagram. The symbols are connected by lateral lines. The CPU 21 displays the generated ladder diagram on the monitor 30.

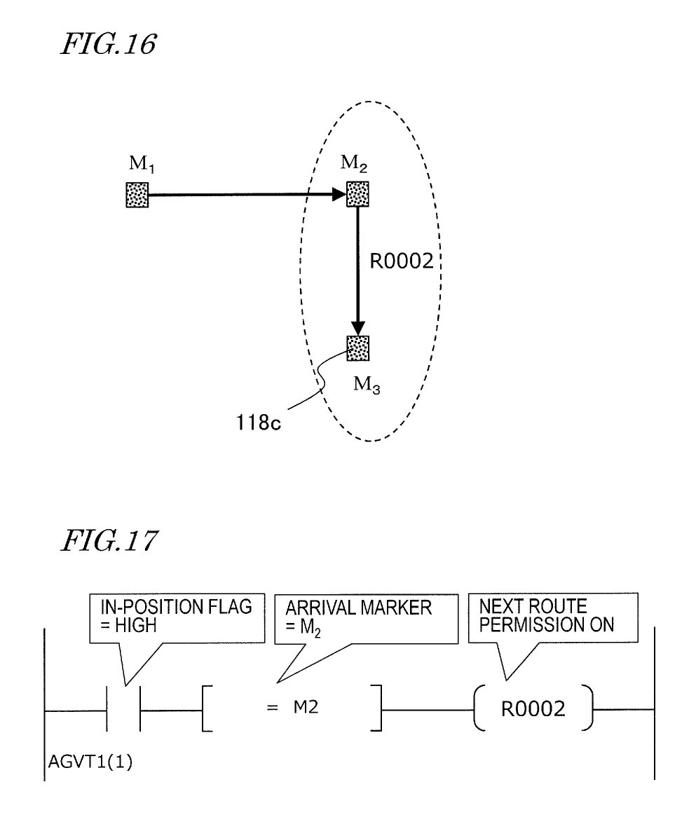

Next, FIG. 16 is referred to.

The user designates the next marker M₃ by using the input device 40. Then, a path heading from the second marker M₂ toward the third marker M₃ may be set.

FIG. 16 shows an example in which the marker object 118c is further displayed according to the user's designation, and thereafter a path of an identifier “R0002” may be set by the program. The CPU 21 performs processing similar to that of the previously-described example to generate a composite statement that defines the movement permission condition concerning the traveling path R0002. FIG. 17 shows an example of a ladder diagram, displayed on the monitor 30, in which the movement permission condition concerning the traveling path R0002 is defined. Since the contents of the composite statement are clear from the description of FIG. 17, any description corresponding to FIG. 15A is omitted from the description of the drawings.

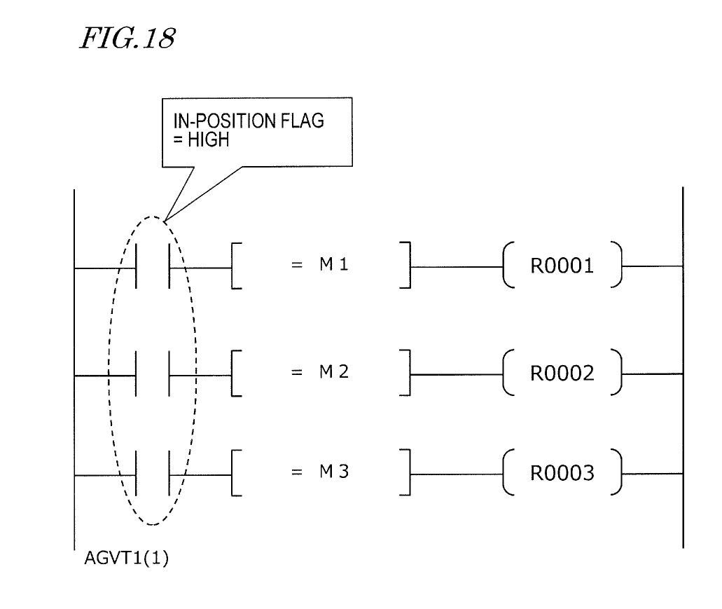

FIG. 18 is a ladder diagram where the movement permission condition to sequentially move the four marker objects shown in FIG. 13 is described. In accordance with the program, the CPU 21 may be capable of generating a composite statement defining the movement permission condition for each traveling path, and expressing them in one ladder diagram. In conventional situations where a PLC would be used, such a ladder diagram would be manually created. According to the processing of a present aspect of the disclosure, the travel management device 20 automatically generates the composite statement, and generates the ladder diagram. The user can significantly reduce the man-hours that were conventionally required.

While the above description illustrates that a straight path connecting between two marker objects may be automatically set, the user may arbitrarily specify a path of his or her own. The user may be able to clarify his/her intension in setting the path, and may set any arbitrary path which may not be limited to a straight line (for example, an arc-shaped path).

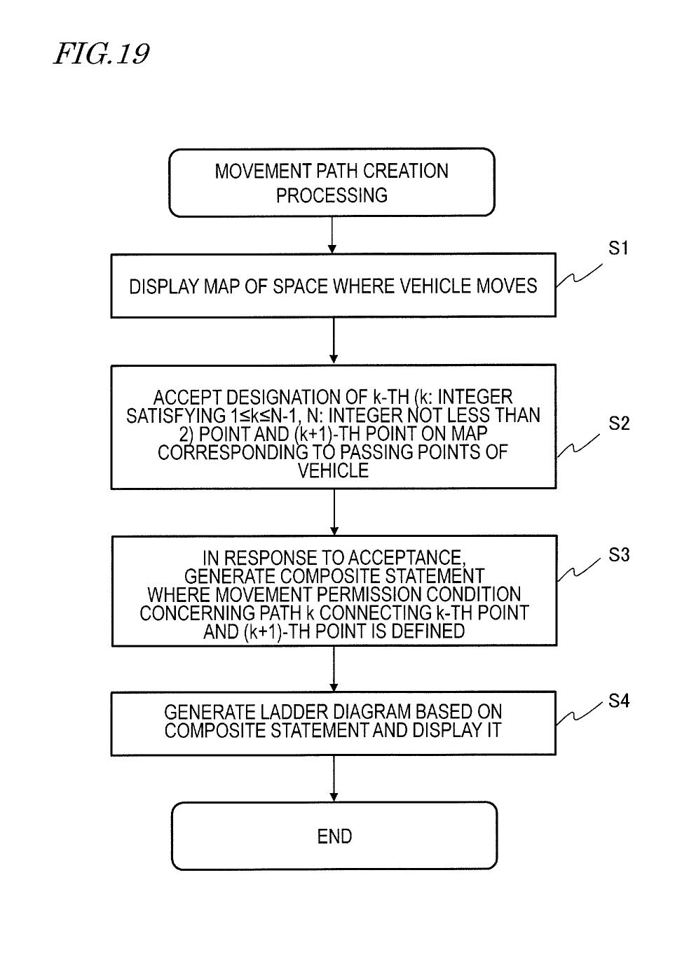

FIG. 19 is an operation flowchart of the travel management device 20 performed by the program according to the present aspect of the disclosure. FIG. 19 shows it in a generalized form.

At step S1, the CPU 21 displays, on the monitor 30, a map of the space where the AGV 10 moves. At step S2, the CPU 21 accepts, from the input device 40, designation of the k-th (k: an integer satisfying 1≤k≤N−1, N: an integer not less than 2) point and the (k+1)-th point on the map corresponding to passing points of the AGV 10. At step S3, in response to acceptance of the designation, the CPU 21 generates a composite statement which may be a set of computer-interpretable statements and in which the movement permission condition concerning the path k connecting the k-th point and the (k+1)-th point is defined. At step S4, the CPU 21 displays the composite statement as a ladder diagram on the monitor 30. Step S4 is additional processing. Steps S1 to S3 may at least be performed.

As is apparent from the description of an aspect of the disclosure given above, a PLC may not be required, while only the travel management device 20 and the application program that executes the above-described processing in the management system 100 may be provided. Not only the cost of a PLC is unnecessary but also it is unnecessary to separately purchase and construct a program development environment or acquire knowledge to create the program. However, a PLC may be provided when an ability to cooperate with an external device is needed.

Next, a method of determining the order of priority among a plurality of movement permission conditions that are simultaneously met will be described. In a present aspect of the disclosure, where the ID of the path may include digits, it is assumed that a path with smaller digits is to be prioritized over others.

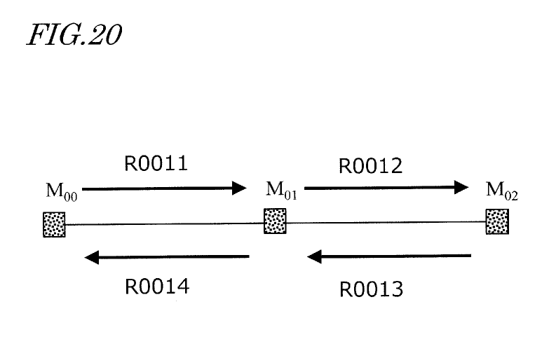

FIG. 20 shows an example of four traveling paths R0011 to R0014 passing through three marker objects M₀₀ to M₀₂. The directions of the arrows indicate the traveling directions. Each path connects two adjoining marker objects.

The marker object M₀₁ is a starting point of the path R0012, and also a starting point of the path R0014. That is, the paths R0012 and R0014 have the same starting position. When the AGV 10 reaches the position corresponding to the marker object M₀₁, the movement permission conditions concerning the branch paths R0012 and R0014 are simultaneously met. In this case, the AGV 10 prioritizes the path R0012 having a lower path ID over the path R0014, which may be ignored. As a result, the AGV 10 having started to move from the Moo toward the path R0011 travels along the following path:

R0011 (M₀₀→M₀₁)→*R0012 (M₀₁→M₀₂)→R0013 (M₀₂→M₀₃)→R0012 (M₀₁→M₀₂)→R0013 (M₀₂→M₀₃)→ . . .

The above-described method, which prioritizes a movement permission condition having a lower path ID, may be an example; alternatively, a movement permission condition having a higher path ID may be prioritized. Further, it is only exemplary that the adopted movement permission condition be determined in accordance with the path ID at all; the movement permission condition that is prioritized over others may be determined by using any other criterion.

As describe above, in accordance with the program of the travel management device 20 of the present aspect of the disclosure, a composite statement can be created, and a ladder diagram can be created from the composite statement. The user can edit the generated composite statement and the like. The travel management device 20 may set an edit permission level, which represents presence/absence of authorization as to whether the edit may be performed or not 0 for each user.

For example, the CPU 21 generates a composite statement, and then, in response to a depression by the user of the button object 63c (FIG. 7) to edit the course, authenticates the user, and reads the data of an edit permission level that may be set for the user. Then, the CPU 21 determines whether an edit of the composite statement may be permitted or not in accordance with the edit permission level. Note that the information representing whether the edit is permitted or not or the edit permission level may be set for each composite statement, instead of for each user.

An illustrative aspect of the disclosure has been described above.

According to the program of a present aspect of the disclosure, a virtual program creating function may be provided that may be capable of outputting a programming language to operate a PLC, e.g., a ladder diagram. By using the output from the program, the affinity with the conventional development environment can be maintained.

Since engineers having already acquired programming skills based on a ladder diagram, etc., can also perform edits by using the edit function, efficient use of human resources can be made. Since the outputted ladder diagram may also be usable in any existing PLC-based management systems, efficient use of such existing management systems can also be made. Therefore, according to the present disclosure, the man-hours required for creating and editing a program, such as a ladder diagram, can be significantly reduced.

The technique of the present disclosure may be widely usable for controlling the operation of a vehicle.

What is claimed is:

1. A computer system for creating a path for a vehicle, the computer system comprising:
a processor;
a memory configured to store a computer program that controls an operation of the processor;
an input device configured to accept an operation by a user; and
a display device,
wherein in accordance with the computer program, the processor
(a) displays, on the display device, a map of a space where the vehicle moves,
(b) accepts, from the input device, designation of a k-th (k: an integer satisfying 1≤k'N−1, N: an integer not less than 2) point and a (k+1)-th point on the map corresponding to passing points of the vehicle, and
(c) generates, in response to the acceptance, a composite statement which is a set of computer-interpretable statements and in which a movement permission condition concerning a path k connecting the k-th point and the (k+1)-th point is defined.

2. The computer system of claim 1, wherein in the composite statement, as the movement permission condition, the path k is defined for which movement is permitted when the following are satisfied:
that the vehicle reaches a predetermined position; and
that the predetermined position is the k-th point.

3. The computer system of claim 2, wherein the processor generates a composite statement in which a movement permission condition concerning a path m (m: an integer satisfying 1≤k<m≤N−1) different from the path k is defined,
wherein the processor assigns unique ID numbers to the path k and the path m, respectively, when generating the composite statements related to the path k and the path m, and
wherein when the k-th point which is a starting point of the path k and an m-th point which is a starting point of the path m represent the same position, the processor gives higher priority to one of the movement permission condition concerning the path k and the movement permission condition concerning the path m in accordance with the ID numbers.

4. The computer system of claim 1, wherein the processor accepts, from the input device, designation of the path k with the k-th point as the starting point and the (k+1)-th point as an ending point in addition to the designation of the k-th point and the (k+1)-th point.

5. The computer program of claim 1, wherein the processor displays the composite statement as a ladder diagram on the display device.

6. The computer program of claim 3, wherein the processor displays the composite statement as a ladder diagram on the display device.

7. The computer program of claim 4, wherein the processor displays the composite statement as a ladder diagram on the display device.

8. The computer system of claim 5, wherein the processor assigns a unique ID number to each path when generating the composite statement related to the path, and
wherein the processor
sets, as a contact point in the ladder diagram, an arrival flag indicating that the vehicle reaches the predetermined position, and sets position information of a point associated with the predetermined position, and
sets the ID number of the path for which movement is permitted, as a coil of an output relay of the ladder diagram, and displays it on the display device.

9. The computer system of claim 6, wherein the processor assigns a unique ID number to each path when generating the composite statement related to the path, and
wherein the processor
sets, as a contact point in the ladder diagram, an arrival flag indicating that the vehicle reaches the predetermined position, and sets position information of a point associated with the predetermined position, and
sets the ID number of the path for which movement is permitted, as a coil of an output relay of the ladder diagram, and displays it on the display device.

10. The computer system of claim 7, wherein the processor assigns a unique ID number to each path when generating the composite statement related to the path, and
wherein the processor
sets, as a contact point in the ladder diagram, an arrival flag indicating that the vehicle reaches the predetermined position, and sets position information of a point associated with the predetermined position, and
sets the ID number of the path for which movement is permitted, as a coil of an output relay of the ladder diagram, and displays it on the display device.

11. The computer system of claim 1, further comprising a storage device,
wherein the processor stores the composite statement and the ladder diagram in the storage device.

12. The computer system of claim 1, wherein the processor sets, for the given user, an edit permission level representing an authorization as to whether edit of the composite statement is permitted or not, and
wherein after generating a composite statement in which a movement permission condition concerning at least one path is defined, the processor determines whether the edit of the composite statement is permitted or not in accordance with the edit permission level.

13. The computer system of claim 3, wherein the processor sets, for the given user, an edit permission level representing an authorization as to whether edit of the composite statement is permitted or not, and
wherein after generating a composite statement in which a movement permission condition concerning at least one path is defined, the processor determines whether the edit of the composite statement is permitted or not in accordance with the edit permission level.

14. The computer system of claim 4, wherein the processor sets, for the given user, an edit permission level representing an authorization as to whether edit of the composite statement is permitted or not, and
wherein after generating a composite statement in which a movement permission condition concerning at least one path is defined, the processor determines whether the edit of the composite statement is permitted or not in accordance with the edit permission level.

15. The computer system of claim 5, wherein the processor sets, for the given user, an edit permission level representing an authorization as to whether edit of the composite statement is permitted or not, and
wherein after generating a composite statement in which a movement permission condition concerning at least one path is defined, the processor determines whether the edit of the composite statement is permitted or not in accordance with the edit permission level.

16. The computer system of claim 12, wherein the processor holds information representing whether the edit is permitted or not for each composite statement.

17. The computer system of claim 13, wherein the processor holds information showing whether the edit is permitted or not for each composite statement.

18. The computer system of claim 14, wherein the processor holds information showing whether the edit is permitted or not for each composite statement.

19. The computer system of claim 15, wherein the processor holds information showing whether the edit is permitted or not for each composite statement.

20. A computer program that is stored on a non-transitory storage medium and that operates a computer system for creating a path for a vehicle, the computer system comprising a processor, a memory, an input device configured to accept an operation by a user and a display device, wherein the computer program causes the processor to
(a) display a map of a space where the vehicle moves, on the display device,
(b) accept, from the input device, designation of a k-th (k: an integer satisfying 1≤k≤N−1, N: an integer not less than 2) point and a (k+1)-th point on the map corresponding to passing points of the vehicle, and
(c) generate, in response to the acceptance, a composite statement which is a set of computer-interpretable statements and in which a movement permission condition concerning a path k connecting the k-th point and the (k+1)-th point is defined.
